(19) United States
(12) Patent Application Publication
(10) Pub. No.: US 2021/0051539 A1
(43) Pub. Date: Feb. 18, 2021

(54) Reordering with Dual Protocol to Reduce Mobility Interruption in Wireless Network

(71) Applicant: MediaTek Singapore Pte. Ltd., Singapore (SG)

(72) Inventor: Yuanyuan Zhang, Beijing (CN)

(21) Appl. No.: 17/087,787

(22) Filed: Nov. 3, 2020

Related U.S. Application Data
(63) Continuation of application No. PCT/CN2019/114706, filed on Oct. 31, 2019.

(30) Foreign Application Priority Data
Oct. 31, 2018 (CN) PCT/CN2018/113098

(51) Int. Cl. H04W 36/00; H04W 36/38; H04W 80/02; H04W 76/30; H04W 76/27

(52) U.S. Cl. CPC H04W 36/0069; H04W 36/38; H04W 76/27; H04W 76/30; H04W 80/02

(57) ABSTRACT

Apparatus and methods are provided for mobility interruption reduction. In novel aspect, the UE receives a handover command indicating a dual-stack HO with a target cell, establishes a target protocol stack for the target cell, with target MAC and RLC entities and associates PDCP entity with both the source cell and the target cell, and performs a PDCP reordering for PDCP PDUs received from both the source cell and the target cell. In one embodiment, the source PDCP entity and the target PDCP entity share one UE PDCP entity associated with both the source cell and the target cell. In one embodiment, upon receiving a release command to release the UE connection with the source cell, the UE disassociates the UE PDCP entity with the source cell, and stops the PDCP reordering.

### CROSS REFERENCE TO RELATED APPLICATIONS

This application is filed under 35 U.S.C. §111(a) and is based on and hereby claims priority under 35 U.S.C. § 120 and § 365(c) from International Application No. PCT/CN2019/114706, titled “Reordering with dual protocol to reduce mobility interruption in wireless network,” with an international filing date of Oct. 31, 2019, which in turn claims priority from International Application No. PCT/CN2018/113098 filed on October 31, 2018. This application is a continuation of International Application No. PCT/CN2019/114706, which claims priority from International Application No. PCT/CN2018/113098. International Application No. PCT/CN2019/114706 is pending as of the filing date of this application, and the United States is a designated state in International Application No. PCT/CN2019/114706. The disclosure of each of the foregoing documents is incorporated herein by reference.

### TECHNICAL FIELD

The disclosed embodiments relate generally to wireless communication, and, more particularly, to reordering with dual protocol to reduce mobility interruption in wireless network.

### BACKGROUND

In the current wireless communication network, handover procedure is performed to support mobility when UE moves among different cells. For example, in the current new radio (NR) system, only basic handover is introduced. The basic handover is mainly based on LTE handover mechanism in which network controls UE mobility based on UE measurement reporting. In the basic handover, similar to LTE, source gNB triggers handover by sending HO request to target gNB and after receiving ACK from the target gNB, the source gNB initiates handover by sending HO command with target cell configuration is applied with target cell configurations.

Interruption during Handover is defined as the shortest time duration supported by the system during which a user terminal cannot exchange user plane packets with any base station during mobility transitions. In NR, Oms interruption is one of the requirements to provide seamless handover UE experience. Mobility performance is one of the most important performance metrics for NR. Therefore, it is important to identify handover solution to achieve high handover performance with Oms interruption, low latency and high reliability.

Improvements and enhancements are required to reduce mobility interruption.

### SUMMARY

Apparatus and methods are provided for mobility interruption reduction. In novel aspect, the UE receives a handover command from a source cell via a source protocol stack in a wireless network, wherein the HO command indicates a dual-stack HO with a target cell, establishes a target protocol stack for the target cell, wherein the target protocol stack includes a target MAC entity for the target cell, a target RLC entity for each DRB, and a target PDCP entity associated with the target cell, and performs a PDCP reordering for PDCP PDUs received from both the source cell and the target cell. In one embodiment, the source PDCP entity and the target PDCP entity share one UE PDCP entity associated with both the source cell and the target cell. In another embodiment, the PDCP reordering is performed at either the PDCP entity or the SDAP entity. In one embodiment, upon receiving a release command to release the UE connection with the source cell from either the target cell or the source cell, the UE disassociates the UE PDCP entity with the source cell, and stops the PDCP reordering. In one embodiment, upon releasing the source connection, the UE sends a PDCP status report to the target cell and receives retransmission of downlink (DL) PDCP PDUs that were not successfully delivered from the target cell, wherein the retransmission is triggered by the PDCP status report. In another embodiment, upon releasing the source connection, the UE transmits and retransmits undelivered uplink (UL) PDCP PDUs of which corresponding PDCP service data units (SDUs) have not been confirmed by lower layers.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary wireless network with mobility interruption reduction in accordance with embodiments of the current invention.

FIG. 2 illustrates an exemplary flow chart of the interruption-optimized/dual-stack handover procedure in accordance with embodiments of the current invention.

FIG. 3 illustrates exemplary block diagrams of the user plane architecture at the network side when interruption-optimized/dual-stack HO is performed in accordance with embodiments of the current invention.

FIG. 4 illustrates an exemplary diagram of the dual-stack handover mobility procedure with inter-gNB mobility in accordance with embodiments of the current invention.

FIG. 5 illustrates exemplary diagrams for dual protocol stacks handling with PDCP reordering upon one protocol stack addition in accordance with embodiments of the current invention.

FIG. 6 illustrates exemplary diagrams for dual protocol stacks handling with PDCP reordering upon one protocol stack removal in accordance with embodiments of the current invention.

FIG. 7 illustrates exemplary diagrams for dual protocol stacks handling with PDCP reordering upon one protocol stack removal in accordance with embodiments of the current invention.

FIG. 8 illustrates exemplary flow charts of interruption-optimized/dual-stack handover procedure at the UE side in accordance with embodiments of the current invention.

FIG. 9 illustrates an exemplary flow chart for mobility interruption reduction procedure in accordance with embodiments of the current invention.

### DETAILED DESCRIPTION

Reference will now be made in detail to some embodiments of the invention, examples of which are illustrated in the accompanying drawings.

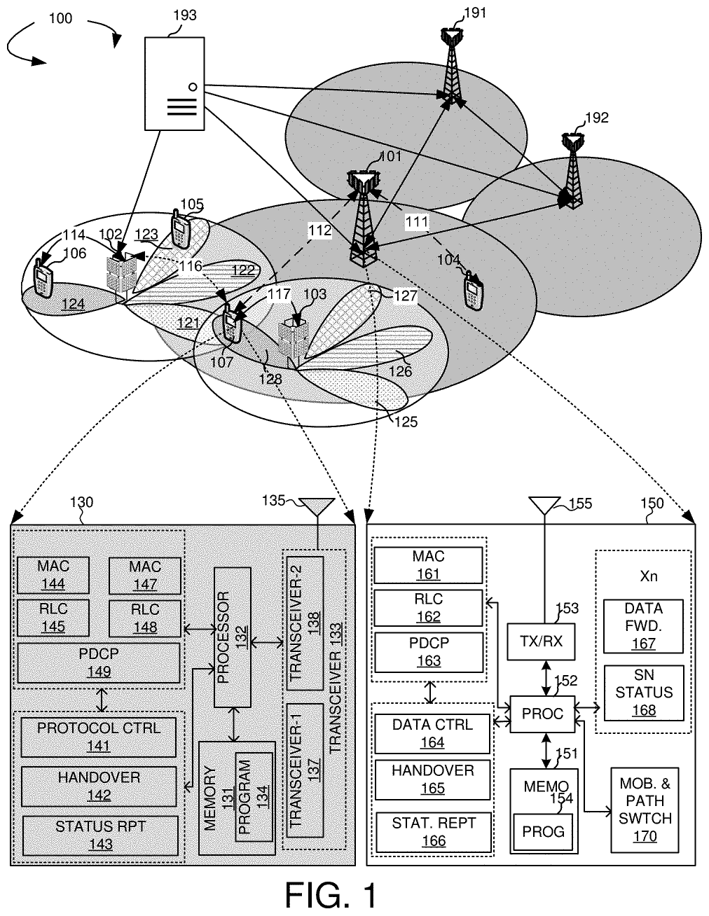

FIG. 1 is a schematic system diagram illustrating an exemplary wireless network 100 with mobility interruption reduction in accordance with embodiments of the current invention. Wireless system 100 includes one or more fixed base infrastructure units forming a network distributed over a geographical region. The base unit may also be referred to as an access point, an access terminal, a base station, a Node-B, an eNode-B, a gNB, or by other terminology used in the art. The network can be homogeneous network or heterogeneous network, which can be deployed with the same frequency or different frequency. The frequency used to provide coverage can be on low frequency e.g. sub-6 GHz or on high frequency e.g. above-6 GHz. As an example, base stations (BSs) 101, 102, 103, 191 and 192 serve a number of mobile stations (MSs, or referred to as UEs) 104, 105, 106 and 107 within a serving area, for example, a cell, or within a cell sector. In some systems, one or more base stations are coupled to a controller forming an access network that is coupled to one or more core networks. All the base stations can be adjusted as synchronous network, which means that that the transmission at the base stations are synchronized in time. On the other hand, asynchronous transmission between different baes stations is also supported. The base station 101, 191, 192 are a macro base station, which provides large coverage. It is either a gNB or an ng-eNB, which providing NR user plane/E-UTRA and control plane protocol terminations towards the UE. The gNBs and ng-eNBs are interconnected with each other by means of the Xn interface, e.g. 175, 176 and 176. The gNBs and ng-eNBs are also connected by means of the NG interfaces, e.g. 172, 173 and 174 to the SGC, more specifically to the AMF (Access and Mobility Management Function) by means of the NG-C interface and to the UPF (User Plane Function) by means of the NG-U interface. UE 104 is moving, which is originally served by gNB 101 through the radio link 111. The cell served by gNB 101 is considered as the serving cell. When UE 104 moves among different cells, the serving cell needs to be changed through handover (HO) and the radio link between the UE and the network changes. All other cells instead of the serving cell is considered as neighboring cells, which can either be detected by UE or configured by the network. Among those neighboring cells, one or multiple cells are selected by the network as candidate cells, which are potentially used as the target cell. The target cell is the cell towards which HO is performed. For example, if the cell of gNB 191 is considered as the target cell. After HO, the connection between UE and the network is changed from gNB 101 to gNB 191. The original serving cell is considered as source cell. In order to reduce the mobility interruption during HO, it is possible that UE can be connected to both gNB 101 and gNB 191 simultaneously for a while and keeps data transmission with the source cell even if the connection with the target cell has been established.

The gNB 102 and gNB 103 are base station, providing coverage of small cells. They may have a serving area overlapped with a serving area of gNB 101, as well as a serving area overlapped with each other at the edge. They can provide coverage through single beam operation or multiple beam operation. In multiple beam operation, the gNBs 102 and 103 may have multiple sectors each of which corresponds to multiple beam to cover a directional area. As shown in FIG. 1, Beams 121, 122, 123 and 124 are exemplary beams of gNB 102, while Beams 125, 126, 127 and 128 are exemplary beams of gNB 103. The coverage of the gNBs 102 and 103 can be scalable based on the number of TRPs radiate the different beams. For example, UE or mobile station 104 is only in the service area of gNB 101 and connected with gNB 101 via a link 111. UE 106 is connected with the HF network only, which is covered by beam 124 of gNB 102 and is connected with gNB 102 via a link 114. UE 105 is in the overlapping service area of gNB 101 and gNB 102. In one embodiment, UE 105 is configured with dual connectivity and can be connected with gNB 101 via a link 113 and gNB 102 via a link 115 simultaneously. UE 107 is in the service areas of gNB 101, gNB 102, and gNB 103. In embodiment, UE 107 is configured with dual connectivity and can be connected with gNB 101 with a link 112 and gNB 103 with a link 117. In embodiment, UE 107 can switch to a link 116 connecting to gNB 102 upon connection failure with gNB 103. Furthermore, all of the base stations can be interconnected with each other by means of the Xn interface. They can be also connected by means of the NG interfaces to the SGC, more specifically to the AMF by means of the NG-C interface and to the UPF by means of the NG-U interface.

FIG. 1 further illustrates simplified block diagrams 130 and 150 for UE 107 and gNB 101, respectively. Mobile station 107 has an antenna 135, which transmits and receives radio signals. A RF transceiver module 133, coupled with the antenna, receives RF signals from antenna 135, converts them to baseband signal, and sends them to processor 132. In one embodiment, the RF transceiver module comprises two RF modules 137 and 138, first RF module 137 is used for a first RF standard, such as an mmW transmitting and receiving, and the second RF module 138 is used for different frequency bands transmitting and receiving which is different from the first RF module 137. RF transceiver 133 also converts received baseband signals from processor 132, converts them to RF signals, and sends out to antenna 135. Processor 132 processes the received baseband signals and invokes different functional modules to perform features in mobile station 107. Memory 131 stores program instructions and data 134 to control the operations of mobile station 107.

Mobile station 107 also includes multiple function modules that carry out different tasks in accordance with embodiments of the current invention. A protocol controller 141 controls the establishment, re-establishment, association and release of the dual protocol stack as well as establishment, re-establishment/reset, association and release of each layer/entity, including the MAC entity, radio link control (RLC) entity, packet data convergence protocol (PDCP) entity, and the service data adaptation protocol (SDAP) entity. A handover controller 142 handles the interruption-reduction/dual-stack HO procedures for the UE. Handover controller 142 processes the HANDOVER REQ and HANDOVER RESPONSE message for the handover execution, handover failure handling, handover completion procedures and PDCP reordering procedures. A PDCP status report module 143 controls the status report procedure.

Mobile station 107 can also be configured with dual protocol stacks. In one novel aspect, the UE/mobile station connects with a source gNB with a source protocol stack. A target protocol stack is created for the handover procedure. In one embodiment, the source protocol stack has a MAC entity 144 and an RLC entity 145. The source protocol stack also has a PDCP entity 149. A target protocol stack is created and established for the handover procedure. A MAC 147 is created for the target cell. An RLC 148 is established to communicate with the target cell. In one embodiment, a target PDCP entity is established for the target cell. In another embodiment, the source PDCP entity 149 is reconfigured to be associated with both the source cell and the target cell.

Similarly, gNB 101 has an antenna 155, which transmits and receives radio signals. A RF transceiver module 153, coupled with the antenna, receives RF signals from antenna 155, converts them to baseband signals, and sends them to processor 152. RF transceiver 153 also converts received baseband signals from processor 152, converts them to RF signals, and sends out to antenna 155. Processor 152 processes the received baseband signals and invokes different functional modules to perform features in gNB 101. Memory 151 stores program instructions and data 154 to control the operations of gNB 101. gNB 101 also has MAC 161, RLC 162, PDCP 163 and an SDAP layer. The protocol/data controller 164 controls the (re)establishment and release of the protocol both the network side and UE side. gNB 101 also conveys the control information through RRC message, such as the RRC reconfiguration message to the UE. A handover module 165 handles handover procedures for gNB 101. A PDCP status report module 166 controls the status report procedure.

gNB 101 also includes multiple function modules for Xn interface that carry out different tasks in accordance with embodiments of the current invention. An SN STATUS TRANSFER modular 168 transfers the uplink PDCP SN and HFN receiver status and the downlink PDCP SN and HFN transmitter status from the source to the target gNB during an Xn handover for each respective RBs for which PDCP SN and HFN status preservation applies. In one embodiment of interruption-optimized HO, the SN status transfer performed just after HANDOVER REQUEST ACKNOWLEDGE message is received. In another embodiment of interruption-optimized HO, the SN status transfer procedure is performed once again upon the source sends the RRC connection release message towards the UE. A data forwarding modular 167 of the source base station may forward in order to the target base station all downlink PDCP SDUs with their SN that have not been acknowledged by the UE. In addition, the source base station may also forward without a PDCP SN fresh data arriving from the CN to the target base station. A mobility and path switching modular 170 controls Xn initiated HO and path switching procedure over the NG-C interface. The handover completion phase for Xn initiated handovers comprises the following steps: the PATH SWITCH message is sent by the target gNB to the AMF when the UE has successfully been transferred to the target cell. The PATH SWITCH message includes the outcome of the resource allocation. The AMF responds with the PATH SWITCH ACK message which is sent to the gNB. The MME responds with the PATH SWITCH FAILURE message in case a failure occurs in the 5GCN.

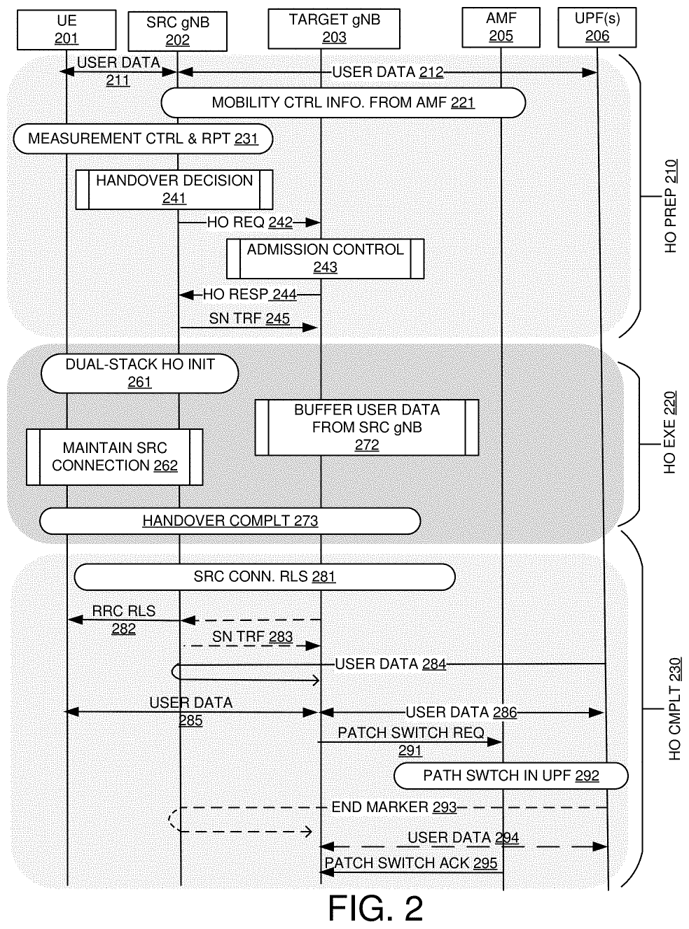

FIG. 2 illustrates an exemplary flow chart of the interruption-reduction/dual-stack handover procedure in accordance with embodiments of the current invention. UE 201 is connected with a source gNB 202 in a wireless network. Neighboring gNBs 203 communicates with gNB 202 and are gNBs in candidate cells. Source gNB 202 and target cell gNB 203 are also connected by means of the NG interfaces, the AMF 205 by means of the NG-C interface and to the UPF 206 by means of the NG-U interface. UE 201 establishes data path with user data 211 to source gNB 202, which establishes user data path 212 with the network. The dual-stack handover includes a HO preparation phase 210, a HO execution phase 220, and a HO completion phase 230.

HO preparation phase 210 includes configuration procedures, handover decision procedure by source gNB 202, handover request and response between source gNB 202 and target gNB 203 and initiation of dual-stack handover. At step 221, source gNB 202 gets mobility control information from AMF 205. The UE context within the source gNB contains information regarding roaming and access restrictions, which were provided either at connection establishment or at the last time advance (TA) update. At step 231, UE 201 performs measurement control and report with source gNB 202. Source gNB 202 configures the UE measurement procedures and the UE reports according to the measurement configuration. At step 241, source gNB 202 determines whether to perform dual-stack handover for UE 201. In one embodiment, source gNB decides to perform dual-stack HO or normal handover based on MeasurementReport and RRM information. At step 242, source gNB 202 issues the Handover Request messages to target gNBs 203. In one embodiment, the source gNB passes one or multiple transparent RRC containers with necessary information to prepare the handover at the target sides. In other embodiment, the source gNB includes the necessary information to prepare the handover as information elements in XnAP messages. In another embodiment, the Handover Request messages sent to the target gNB includes the interruption-optimized HO indication, which informs the target gNBs to perform interruption-optimized HO. In one embodiment, a transparent RRC container is transmitted to the target gNB. In one embodiment, the information includes at least the target cell ID, KgNB*, the C-RNTI of the UE in the source gNB, RRM-configuration, the current QoS flow to DRB mapping rules applied to the UE, the minimum system information from source gNB, the UE capabilities for different RATS, PDU session related information, and can include the UE reported measurement information including beam-related information if available. The PDU session related information includes QoS flow level QoS profile(s) and the slice information when supported. At step 243, the target cell gNB 203 upon receiving HO Request from source gNB 202, performs admission control. At step 244, target gNB 203 sends HO Request ACK to source gNB 202. In one embodiment, HANDOVER REQUEST ACKNOWLEDGE includes a transparent container to be sent to the UE as an RRC message to perform the handover. In another embodiment, HANDOVER REQUEST ACKNOWLEDGE includes necessary information as information element of XnAP message to be sent to the UE to perform the handover. In yet another embodiment, the HANDOVER REQUEST ACKNOWLEDGE includes the security algorithm and security key used in the target gNB. At step 245, source gNB 202 sends the SN STATUS TRANSFER message to the target gNB 203 and performs data forwarding immediately to the target gNB 203 so that there will be data available for transmission at the target gNB when the connection with the target gNB is established for the UE.

In the HO execution phase 220, the dual-stack HO procedure is initiated when the UE maintains connection with the source gNB. At step 261, the dual-stack handover is initiated. In one embodiment, source gNB 202 triggers the Uu handover by sending an RRCReconfiguration message indicates that interruption-optimized/dual-stack HO is to be performed by the UE. UE should maintain the connection with the source cell when perform HO with the target cell. In order to keep data transmission with the source cell, part or all RRC configuration provided by the source gNB is kept. In one embodiment, the lower-layer configuration at least for the MCG are kept. In one embodiment, at least one DRB and the corresponding DRB configuration is kept. For SRBs and SRB related configuration, in one embodiment, SRBs and the configuration for SRBs including SRB1 and SRB2 are kept at the UE side; in one embodiment, only SRB1 and the configuration for SRB1 are kept at the UE side.

At step 262, The UE maintains the connection with the source cell and synchronizes to the target cell. At step 272, the source gNB transfers the buffered data to the target gNB. At step 273, the UE sends handover complete message to the network. It completes the RRC handover procedure by sending RRCReconfigurationComplete message to the network. In one embodiment, the message as the response to the HO command is the RRCReconfigurationComplete message. In one embodiment, the response message is sent to the target gNB. In one embodiment, the response message is sent to both the source gNB and the target gNB. In one embodiment, another UL RRC message is used as the response to the HO command. The UL RRC message is transmitted towards the source gNB indicating that the connection with the target gNB is established.

HO complete phase 230 includes source cell release procedure, path switching procedures and possible SN status transfer procedure.

In one embodiment, at step 281 source connection release is coordinated between the source gNB and the target gNB. It is used to initiate the release of the UE context and UE connection at the source gNB. The procedure may be initiated either by the source gNB or by the target gNB. In one embodiment, at step 282, the source connection release is initiated by the source cell. The source gNB sends source connection release required message and the target gNB responds source connection release confirm message. In another embodiment, at step 282, the source connection release is initiated by the target cell. The target gNB sends source connection release request message and the source gNB responds source connection release acknowledge message. In one embodiment, the source gNB can reject the request. In yet another embodiment, the UE releases the connection with the source autonomously upon completion of the handover to the target cell. In one embodiment, the target cell or the source cell sends RRC connection release message to the UE and release UE context. In another embodiment, the network does not send release messages to the UE. The UE releases the source connection automatically or upon detecting other conditions, such as detecting the Radio Link Failure towards the source gNB, or the DataInactivityTimer at the network side expires.

At step 283, source gNB 202 sends the SN STATUS TRANSFER message to the target gNB 203. User data 284 is established subsequently. UE 201 establishes new data path 285 with target cell. New data path 286 is established between the target cell and the network. At step 291, target gNB sends a PATH SWITCH REQUEST message to AMF to trigger 5GC to switch the DL data path towards the target gNB and to establish an NG-C interface instance towards the target gNB. At step 292, path switch is performed in UPF. At step 293, 5GC switches the DL data path towards the target gNB. The UPF sends one or more “end marker” packets on the old path to the source gNB per PDU session/tunnel and then can release any U-plane/TNL resources towards the source gNB. At step 294, the data path between the new target cell and the network is established. At step 295, AMF 205 confirms the PATH SWITCH REQUEST message with the PATH SWITCH REQUEST ACKNOWLEDGE message.

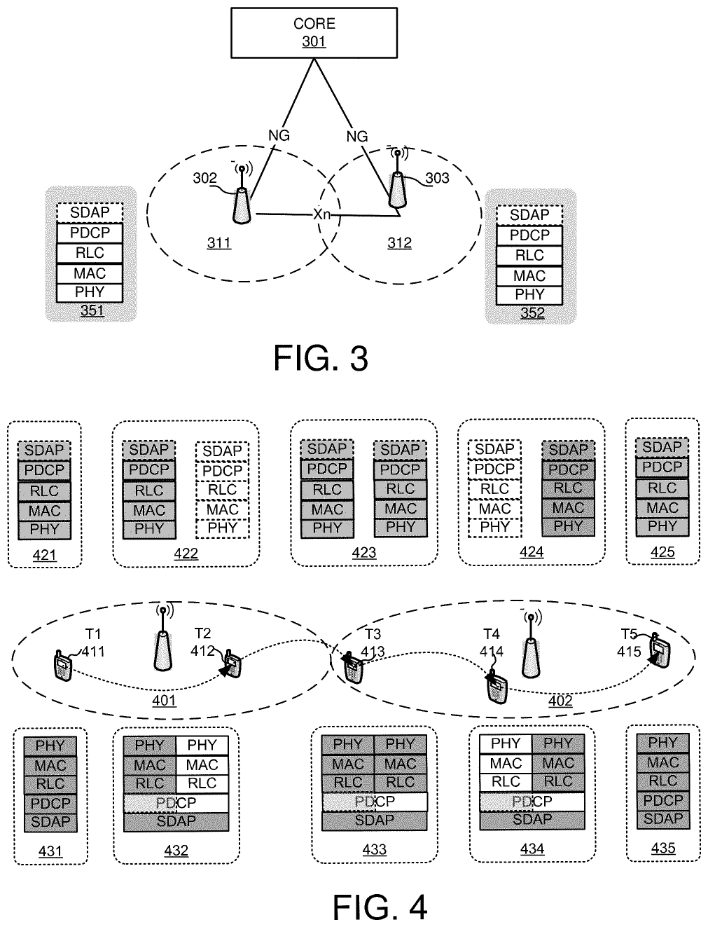

FIG. 3 illustrates exemplary block diagrams of the user plane architecture at the network side when interruption-optimized/dual-stack HO is performed in accordance with embodiments of the current invention. The intra 5G intra-RAT handover is normally based on Xn-based handover. HO is performed between gNBs through Xn interface, which are connected to the NR corn network. Each gNB has the protocol stacks including SDAP, PDCP, RLC, MAC and PHY layers. A gNB 311 and a gNB 312 are both 5G gNBs with a protocol stack 351 and 352, respectively. gNB 311 and gNB 312 connects with the Core 301 via NG connection. gNB 311 and gNB 312 connect with each other via Xn interface. Protocol stacks 351 and 352 includes PHY, MAC, RLC, PDCP and optionally SDAP.

FIG. 4 illustrates an exemplary diagram of the dual-stack handover mobility procedure with inter-gNB mobility in accordance with embodiments of the current invention. Cell 401 and cell 402 are neighboring cells served by gNB1 and gNB2, respectively. UE moves among different gNBs. Each gNB has the protocol stack of SDAP, PDCP, RLC, MAC and PHY layers. At T1 411, the UE is connected with gNB1 of cell 401 via protocol stack 431 including SDAP, PDCP, RLC, MAC and PHY layers. gNB1 has the peer protocol stack 421. At T2 412, UE moves to the cell edge. gNB1 determines to perform HO for the UE to gNB2. In order to minimize the mobility interruption, simultaneous data transmission/reception with gNB1 and gNB2 should be supported. A protocol stack 432 with SDAP, PDCP, RLC, MAC and PHY layers for gNB2 are established. The HO command indicating to establish SDAP, PDCP, RLC and create MAC layer at the UE side. In one embodiment, UE protocol stack 432 includes a source protocol stack and a target protocol stack. The UE creates a MAC entity for the target cell and establishes the target RLC for each DRB. In one embodiment, the source protocol stack and the target protocol stack share the same UE PDCP entity. The UE associates the UE PDCP entity with both the source protocol stack and the target protocol stack. The source protocol stack and the target protocol stack also share the same SDAP entity. The gNB stack 422 has the gNB1 protocol active while the gNB2 protocol stack does not communicate with the UE yet. At T3 413 after establishing the protocol stack for the target gNB, PDCP reordering function is enabled. PDCP PDUs of a DRB are transmitted through the gNB1 and gNB2 protocol stacks of 423 via two PDCP entities located in gNB1 and gNB2 respectively. A PDCP reordering function at the UE side performs PDCP reordering on the PDCP PDUs received from the two PDCP entities. The UE protocol stack 433 transmits and receives data packet to/from the source cell and the target cell simultaneously. UE protocol stack 433 includes source MAC entity, source RLC entity, target MAC entity, target RLC entity, and shared UE PDCP entity and optionally, shared UE SDAP entity. At T4 414, when UE moves out of the coverage of the source cell, the radio link with the source cell is not reliable enough for data packets transmission, such as due to RLF. The gNB1 stops data transmission. UE only receives PDCP PDUs from gNB2. The gNB protocol stack 424 only has the target gNB protocol active while the source gNB protocol is inactive. The UE protocol stack 434 has the source protocol stack inactive while the target protocol stack is active. At time T5 415, gNB1 removes the protocol stack with the UE. The gNB protocol stack 425 only has the target protocol stack. The UE protocol stack 435 goes back to one set of protocol stack entities.

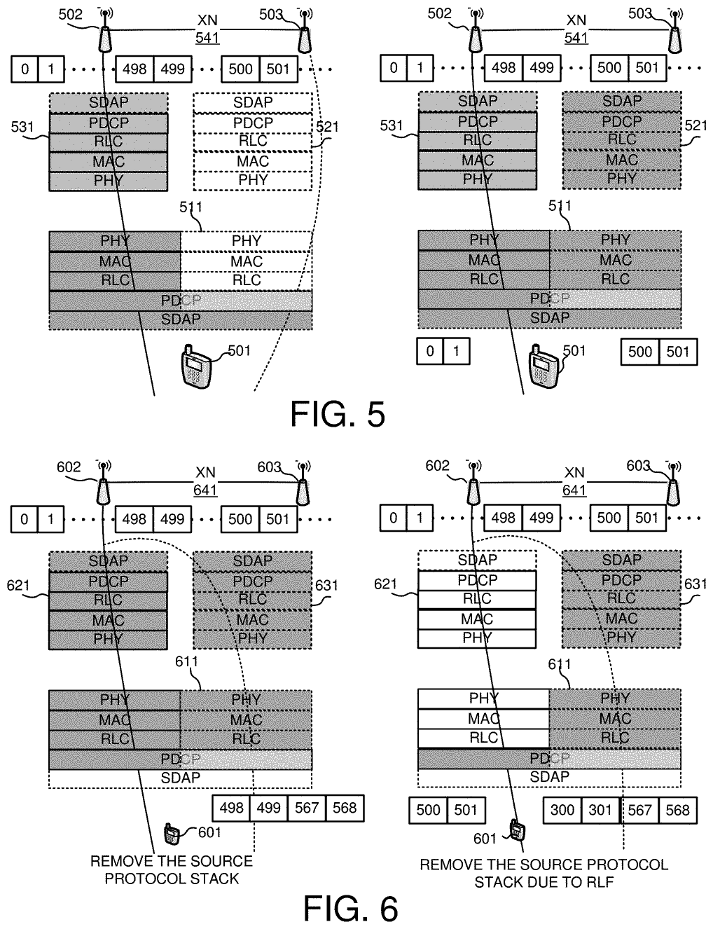

FIG. 5 illustrates exemplary diagrams for dual protocol stacks handling with PDCP reordering upon one protocol stack addition in accordance with embodiments of the current invention. UE 501 is connected with source gNB 502 with protocol stack 531. Source gNB 502 is connected with neighboring gNB the target gNB 503, with protocol stack 521, via Xn interface 541. Upon reception of interruption-optimized HO command, UE 501 updates protocol stack 511. UE 501 creates target MAC, establishes RLC entity, reconfigures the PDCP entity to be associated with both the target can the source cell. Optionally, the SDAP entity is also reconfigured to be associated with both the source and the target cells. The PDCP and RLC entity are established for each DRB requiring Oms interruption. Consequently, there are two protocols for each DRB. Meanwhile, the PDCP reordering function is enabled. The source gNB reserves a range of SN e.g. 0-499 for PDCP SDU transmission through the source gNB and forwards the remaining PDCP SDUs to the target gNB. Furthermore, it sends the SN status transfer to the target gNB and give a range of SN for target gNB to use, e.g. >500 or 500˜1000. Then UE receives PDCP PDUs from both of the PDCP entities corresponding to the source gNB and target gNB. For example, PDCP PDU 0 and 1 are received from the source gNB, while PDCP PDUs 500 and 501 re received from the target gNB. Since the PDCP PDUs are received out of order, PDCP reordering function is used to guarantee in-sequence delivery and duplication avoidance. When the PDCP PDUs with SN from 2˜499 are received, all the stored PDCP SDUs will be delivered to the upper layer. In one embodiment, PDCP reordering function is enabled by the reconfiguration of the reordering timer.

FIG. 6 illustrates exemplary diagrams for dual protocol stacks handling with PDCP reordering upon one protocol stack removal in accordance with embodiments of the current invention. UE 601 is connected with source gNB 602 with protocol stack 621 and target gNB 603, with protocol stack 631. Source gNB 602 is connected with neighboring gNB the target gNB 603 via Xn interface 641. During the handover procedure, UE protocol stack 611 has a target protocol stack and a source protocol stack. In one embodiment, the source and target protocol each has their own MAC and RLC entities while shares the same PDCP entity. Upon completion of the handover, UE 601 updates protocol stack 611. UE received PDCP PDUs for the same DRB from both the source the cell and the target cell. In one embodiment, all the PDCP SDUs buffered at the source gNB can be successfully delivered to the UE or all the reserved SN are used up at the source cell. In this case, the RRC connection of the source gNB and the protocol stack 611 is explicitly released by either the source gNB or the target gNB through dedicated RRC message. UE releases the protocol for the source cell. Since all the PDCP PDUs are successfully delivered e.g. PDCP PDUs with SN less than 567, UE delivers all received PDCP SDUs to the upper layer.

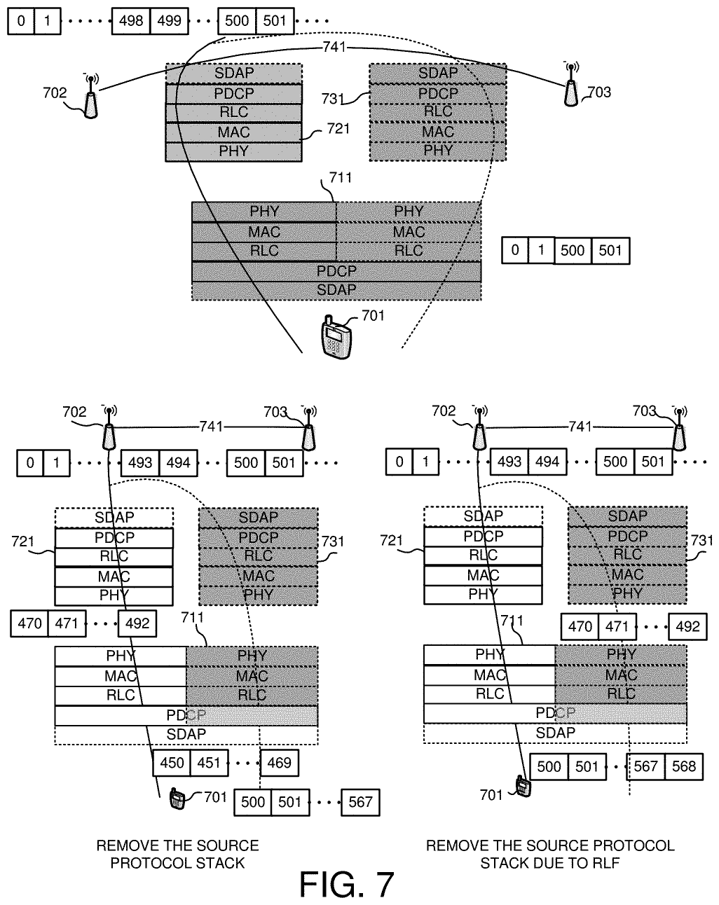

FIG. 7 illustrates exemplary diagrams for dual protocol stacks handling with PDCP reordering upon one protocol stack removal in accordance with embodiments of the current invention. UE 701 is connected with source gNB 702 with protocol stack 721 and target gNB 703, with protocol stack 731. Source gNB 702 is connected with neighboring gNB the target gNB 703 via Xn interface 741. During the handover procedure, UE protocol stack 711 has a target protocol stack and a source protocol stack. In one embodiment, the source and target protocol each has their own MAC and RLC entities while shares the same PDCP entity. UE 701 received PDCP PDUs for the same DRB from both the source the cell and the target cell. In one embodiment, not all the PDCP SDUs buffered at the source gNB are successfully delivered to the UE or the reserved SN are not used up at the source cell. For example, when the connection with source cell is released, the successful delivery of some PDCP PDUs e.g. with SN from SN470 to SN492 has not been confirmed by lower layers. Upon reception of the release message, UE will discard all stored PDCP SDUs and PDCP PDUs in the transmitting PDCP entity, deliver the PDCP SDUs stored in the receiving PDCP entity to upper layers in ascending order of associated COUNT values and release the PDCP entity for the radio bearer. At the same time, the status report should be triggered at the UE receiver side. It will trigger the retransmission of the unsuccessfully delivered PDCP PDUs with SN from SN470 to SN492 from the target side.

For AM DRBs, from the transmission side, from the first PDCP SDU for which the successful delivery of the corresponding PDCP Data PDU has not been confirmed by lower layers, retransmission or transmission of all the PDCP SDUs already associated with PDCP SNs in ascending order of the COUNT values associated to the PDCP SDU prior to the PDCP entity release should be transmitted or retransmitted at the target gNB.

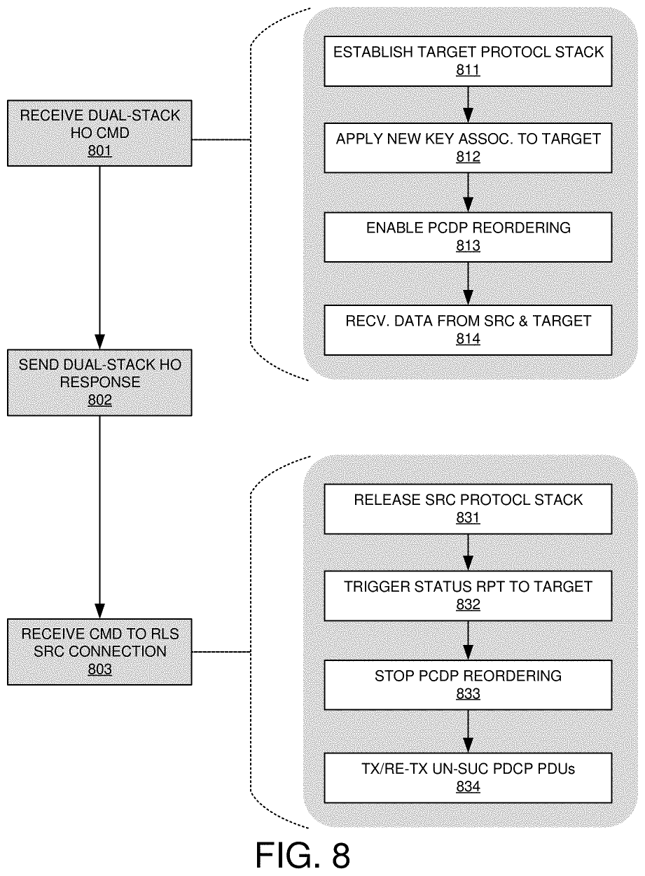

FIG. 8 illustrates exemplary flow charts of interruption-optimized/dual-stack handover procedure at the UE side in accordance with embodiments of the current invention. At step 801, one type of HO command, such as interruption-optimized/dual-stack HO command is received, which indicating that simultaneous connectivity with both the source cell and the target cell should be performed. At user plane, UE established the protocol stack for the target cell at step 811. The UE applies a new key for the new protocol associated to the target cell at step 812. Then the PDCP reordering function is enabled at step 813 and receives the PDCP PDUs from both the source cell and the target cell simultaneously for the same DRB at step 814. At step 802, the UE responds the HO command. At step 803, the UE receives the RRC message to release the connection with the source cell. Upon receive the RRC message, the UE releases both the transmitting PDCP entity and receiving PDCP entity at step 831. From the receiver side, UE triggers a PDCP status report at step 832, which triggers the retransmission of the DL PDCP PDUs which has not been successfully delivered before PDCP release. Furthermore, UE also stops the reordering function in step 833. From the transmitter side, the UE transmits and retransmits from the first PDCP SDU for which the successful delivery of the corresponding PDCP Data PDU has not been confirmed by lower layers. The UE retransmits or transmits of all the PDCP SDUs already associated with PDCP SNs in ascending order of the COUNT values associated to the PDCP SDU prior to the PDCP entity release at step 834.

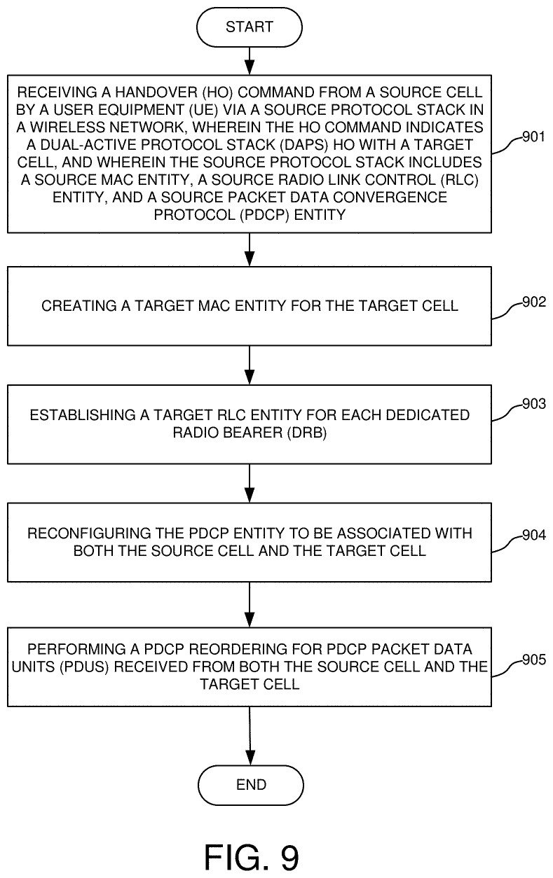

FIG. 9 illustrates an exemplary flow chart for mobility interruption reduction procedure in accordance with embodiments of the current invention. At step 901, the UE receives a handover (HO) command from a source cell via a source protocol stack in a wireless network, wherein the HO command indicates a dual-stack HO with a target cell, and wherein the source protocol stack includes a source MAC entity, a source RLC entity, and a source PDCP entity. At step 902, the UE establishes a target protocol stack for the target cell, wherein the target protocol stack includes a target MAC entity for the target cell, a target RLC entity for each DRB, and a target PDCP entity associated with the target cell. At step 903, the UE performs a PDCP reordering for PDCP PDUs received from both the source cell and the target cell.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving a handover (HO) command from a source cell by a user equipment (UE) via a source protocol stack in a wireless network, wherein the HO command indicates a dual-active protocol stack (DAPS) HO with a target cell, and wherein the source protocol stack includes a source MAC entity, a source radio link control (RLC) entity, and a source packet data convergence protocol (PDCP) entity;
creating a target MAC entity for the target cell;
establishing a target RLC entity for each data radio bearer (DRB);
reconfiguring the PDCP entity to be associated with both the source cell and the target cell; and
performing a PDCP reordering for PDCP packet data units (PDUs) received from both the source cell and the target cell.

2. The method of claim 1, wherein the source PDCP entity and the target PDCP entity share one UE PDCP entity associated with both the source cell and the target cell.

3. The method of claim 2, wherein the PDCP reordering is performed at the UE PDCP entity or a service data adaptation protocol (SDAP) entity.

4. The method of claim 3, further comprising:
receiving a release command to release a UE connection with the source cell.

5. The method of claim 4, wherein the release command is received from at least one sender comprising the source cell and the target cell.

6. The method of claim 4, further comprising:
disassociating the UE PDCP entity with the source cell upon receiving the release command.

7. The method of claim 4, further comprising:
stopping the PDCP reordering upon receiving the release command.

8. The method of claim 4, further comprising:
triggering PDCP status report at UE PDCP entity; and
receiving retransmission of downlink (DL) PDCP SDUs that were not successfully delivered from the source cell, wherein the retransmission is triggered by the PDCP status report.

9. The method of claim 4, further comprising:
transmitting and retransmitting undelivered uplink (UL) PDCP PDUs of which corresponding PDCP service data units (SDUs) have not been confirmed by lower layers to the target cell.

10. The method of claim 1, wherein the DAPS HO command indicates the UE to maintain connections with the source cell and the target cell simultaneously.

11. A user equipment (UE), comprising:
a transceiver that transmits and receives radio frequency (RF) signal in a wireless network;
a memory; and
a processor coupled to the memory, the processor configured to receive a handover (HO) command from a source cell via a source protocol stack, wherein the HO command indicates a dual-active protocol stack (DAPS) HO with a target cell, and wherein the source protocol stack includes a source MAC entity, a source radio link control (RLC) entity, and a source packet data convergence protocol (PDCP) entity;
create a target MAC entity for the target cell;
establish a target RLC entity for each data radio bearer (DRB);
reconfigure the PDCP entity to be associated with both the source cell and the target cell; and
perform a PDCP reordering for PDCP packet data units (PDUs) received from both the source cell and the target cell.

12. The UE of claim 11, wherein the source PDCP entity and the target PDCP entity share one UE PDCP entity associated with both the source cell and the target cell.

13. The UE of claim 12, wherein the PDCP reordering is performed at the UE PDCP entity or a service data adaptation protocol (SDAP) entity.

14. The UE of claim 13, wherein the processor is further configured to receive a release command to release a UE connection with the source cell.

15. The UE of claim 14, wherein the release command is received from at least one sender comprising the source cell and the target cell.

16. The UE of claim 14, wherein the processor is further configured to disassociate the UE PDCP entity with the source cell upon receiving the release command.

17. The UE of claim 14, wherein the processor is further configured to stop the PDCP reordering upon receiving the release command.

18. The UE of claim 14, wherein the processor is further configured to trigger PDCP status report at UE PDCP entity; and receive transmission of downlink (DL) PDCP SDUs that were not successfully delivered from the source cell, wherein the retransmission is triggered by the PDCP status report.

19. The UE of claim 14, wherein the processor is further configured to transmit and retransmit undelivered uplink (UL) PDCP PDUs of which corresponding PDCP service data units (SDUs) have not been confirmed by lower layers to the target cell.

20. The UE of claim 11, wherein the DAPS HO command indicates the UE to maintain connections with the source cell and the target cell simultaneously.
